(19) United States
(12) Patent Application Publication
(10) Pub. No.: US 2020/0280814 A1
(43) Pub. Date: Sep. 3, 2020

(54) AUGMENTED REALITY AUDIO PLAYBACK CONTROL

(71) Applicant: Bose Corporation, Framingham, MA (US)

(72) Inventors: Charles Reuben Taylor, Milford, CT (US); Utsav Prakash Shah, Shrewsbury, MA (US); Vijayan P. Sarathy, Littleton, MA (US); Gabriel Quinn Butterick, Waltham, MA (US); Arthur Allen Gibson, Sudbury, MA (US); Jeffrey Hunter, West Orange, NJ (US); Jaime Abramson, Watertown, MA (US); Daniel Rosenblatt, Natick, MA (US); Yehonatan Meschede-Krasa, Somerville, MA (US)

(21) Appl. No.: 16/289,940

(22) Filed: Mar. 1, 2019

(51) Int. Cl. H04S 7/00; G10K 11/178; G06F 3/16

(52) U.S. Cl. CPC H04S 7/303; G06F 3/165; G10K 11/178

(57) ABSTRACT

Various implementations include audio devices and related computer-implemented methods for controlling playback of augmented reality (AR) audio. Certain implementations include approaches for initiating AR audio playback at an audio device independent of a detected geographic location of the device. Additional implementations include approaches for initiating AR audio playback based upon one or more geographic location-specific indicators for the device.

### TECHNICAL FIELD

This disclosure generally relates to augmented reality (AR) audio experiences. More particularly, the disclosure relates to audio devices and related methods for rendering AR audio experiences based upon one or more detected conditions.

### BACKGROUND

Portable electronic devices, including headphones, audio eyeglasses and other wearable audio systems are becoming more commonplace. These portable electronic devices can enable immersive user experiences, for example, using audio to augment the user's perception of the surrounding world. However, these conventional systems fail to capitalize on the various benefits that augmented audio can provide.

### SUMMARY

All examples and features mentioned below can be combined in any technically possible way.

Various implementations include audio devices and related computer-implemented methods for controlling playback of augmented reality (AR) audio. Certain implementations include approaches for initiating AR audio playback at an audio device independent of a detected geographic location of the device. Additional implementations include approaches for initiating AR audio playback based upon one or more geographic location-specific indicators for the device.

In some particular aspects, a computer-implemented method of controlling playback of augmented reality (AR) audio at a wearable audio device includes: receiving data indicating an AR audio playback condition attributed to a user of the wearable audio device is satisfied, where the AR audio playback condition is independent of a detected geographic location of the wearable audio device; and initiating playback of the AR audio at the wearable audio device in response to receiving the data indicating that the AR audio playback condition is satisfied.

In other particular aspects, a wearable audio device includes: an acoustic transducer having a sound-radiating surface for providing an audio output; and a control system coupled with the acoustic transducer, the control system configured to: receive data indicating an AR audio playback condition attributed to a user of the wearable audio device is satisfied, where the AR audio playback condition is independent of a detected geographic location of the wearable audio device; and initiate playback of AR audio at the acoustic transducer in response to receiving the data indicating that the AR audio playback condition is satisfied.

In additional particular aspects, a computer-implemented method of controlling playback of augmented reality (AR) audio at a wearable audio device includes: receiving data indicating an AR audio playback condition attributed to a user of the wearable audio device is satisfied, where the data indicating the AR audio playback condition is satisfied comprises at least one of: location pattern data about a common travel pattern for the user, location pattern data about a popular travel pattern for a group of users, where the common travel pattern for the user or the popular travel pattern intersects a current geographic location of the wearable audio device, location type data indicating a type of geographic location proximate the wearable audio device, wherein the AR audio differs based upon the indicated type of geographic location, demographic data indicating at least one demographic attribute of the geographic location proximate the wearable audio device, where the AR audio differs based upon the at least one demographic attribute of the indicated geographic location, or social media data indicating a social media connection with another user of a social media platform, where the current geographic location of the wearable audio device is proximate to a geographic location having an audio pin related to the other user of the social media platform; and initiating playback of the AR audio at the wearable audio device in response to receiving the data indicating that the AR audio playback condition is satisfied.

Implementations may include one of the following features, or any combination thereof.

In some cases, the data indicating that the AR audio playback condition is satisfied includes: clock data indicating a current time of day, where the AR audio differs based upon the indicated current time of day, or weather data indicating a weather condition proximate the wearable audio device, where the AR audio differs based upon the indicated weather condition.

In particular implementations, the data indicating the AR audio playback condition is satisfied includes speed data indicating a speed at which the wearable audio device is moving or a rate of acceleration for the wearable audio device, where the AR audio differs based upon the indicated speed or rate of acceleration.

In certain aspects, the data indicating the AR audio playback condition is satisfied includes relative location data indicating the wearable audio device is proximate to a plurality of additional wearable audio devices associated with corresponding users executing a common application on the wearable audio device or a paired audio gateway.

In some cases, the data indicating the AR audio playback condition is satisfied includes celestial event data indicating a current or impending celestial event.

In particular aspects, the data indicating the AR audio playback condition is satisfied includes current event data indicating a breaking news story, a new release of a product, or a new release of an artistic work.

In certain implementations, the method further includes activating a noise canceling function on the wearable audio device during the playback of the AR audio.

In some cases, the noise canceling function is based upon settings defined by the user or settings defined by a provider of content in the AR audio.

In particular aspects, the method further includes: detecting proximity of an additional wearable audio device associated with an additional user executing a common application on the wearable audio device or a paired audio gateway; and prompting the user to initiate peer-to-peer (P2P) communication with the additional user in response to detecting the proximity of the additional wearable audio device to the wearable audio device.

In certain implementations, the data indicating the AR audio playback condition is satisfied includes application execution data for an application executing on the wearable audio device or a paired audio gateway, the application providing in-experience voting or polling, where the AR playback includes a voting question or a polling question comprising a request for feedback from the user.

In some cases, the wearable audio device includes an active noise reduction (ANR) circuit coupled with the control system, where the control system is configured to activate the ANR circuit during the playback of the AR audio.

In particular aspects, activating the ANR circuit is based upon settings defined by the user or settings defined by a provider of content in the AR audio.

In certain cases, the method further includes storing AR audio playback data attributed to the user and a geographic location to prevent playback of AR audio previously deprioritized by the user.

In some implementations, the method further includes providing an audio prompt to initiate playback of the AR audio to the user via the acoustic transducer, where initiating playback of the AR audio at the wearable audio device is further performed in response to actuation of the prompt by the user.

Two or more features described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

FIG. 1 is a schematic depiction of an example audio device according to various implementations.

FIG. 2 is data flow diagram illustrating interaction between devices running an augmented reality audio engine in an environment according to various implementations.

FIG. 3 is a flow diagram illustrating processes performed by the augmented reality audio engine shown in FIG. 2.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

This disclosure is based, at least in part, on the realization that a scene in an augmented audio environment can be rendered based upon one or more playback conditions. Certain implementations include approaches for controlling playback of augmented reality (AR) audio at a wearable audio device based upon conditions that are independent of a detected geographic location of that device. Additional implementations include approaches for controlling playback of AR audio at a wearable audio device based upon conditions that are related to the detected geographic location of that device.

Commonly labeled components in the FIGURES are considered to be substantially equivalent components for the purposes of illustration, and redundant discussion of those components is omitted for clarity.

Aspects and implementations disclosed herein may be applicable to a wide variety of personal audio devices, such as a portable speaker, headphones, and wearable audio devices in various form factors, such as watches, glasses, neck-worn speakers, shoulder-worn speakers, body-worn speakers, etc. Unless specified otherwise, the term headphone, as used in this document, includes various types of personal audio devices such as around-the-ear, over-the-ear and in-ear headsets, earphones, earbuds, hearing aids, or other wireless-enabled audio devices structured to be positioned near, around or within one or both ears of a user. Unless specified otherwise, the term wearable audio device, as used in this document, includes headphones and various other types of personal audio devices such as head, shoulder or body-worn acoustic devices that include one or more acoustic drivers to produce sound without contacting the ears of a user. Some particular aspects disclosed may be particularly applicable to personal (wearable) audio devices such as glasses, headphones, earphones or other head-mounted audio devices. It should be noted that although specific implementations of personal audio devices primarily serving the purpose of acoustically outputting audio are presented with some degree of detail, such presentations of specific implementations are intended to facilitate understanding through provision of examples and should not be taken as limiting either the scope of disclosure or the scope of claim coverage.

Aspects and implementations disclosed herein may be applicable to personal audio devices that either do or do not support two-way communications, and either do or do not support active noise reduction (ANR). For personal audio devices that do support either two-way communications or ANR, it is intended that what is disclosed and claimed herein is applicable to a personal audio device incorporating one or more microphones disposed on a portion of the personal audio device that remains outside an ear when in use (e.g., feedforward microphones), on a portion that is inserted into a portion of an ear when in use (e.g., feedback microphones), or disposed on both of such portions. Still other implementations of personal audio devices to which what is disclosed and what is claimed herein is applicable will be apparent to those skilled in the art.

Audio Device

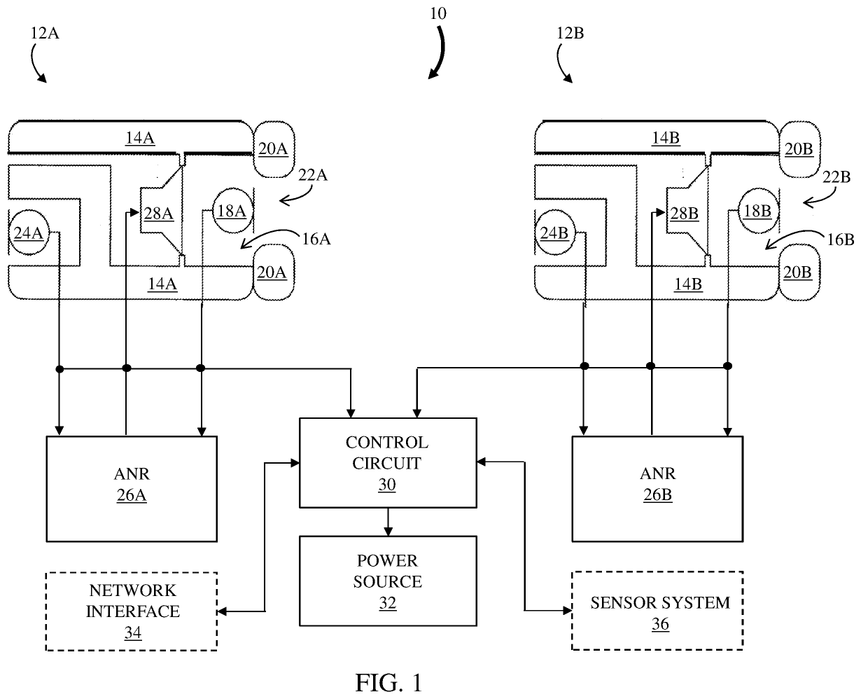

FIG. 1 is a block diagram of an example of a personal audio device 10 having two earpieces 12A and 12B, each configured to direct sound towards an ear of a user. Reference numbers appended with an “A” or a “B” indicate a correspondence of the identified feature with a particular one of the earpieces 12 (e.g., a left earpiece 12A and a right earpiece 12B). Each earpiece 12 includes a casing 14 that defines a cavity 16. In some examples, one or more internal microphones (inner microphone) 18 may be disposed within cavity 16. In implementations where personal audio device (or simply, audio device) 10 is ear-mountable, an ear coupling 20 (e.g., an ear tip or ear cushion) attached to the casing 14 surrounds an opening to the cavity 16. A passage 22 is formed through the ear coupling 20 and communicates with the opening to the cavity 16. In some examples, an outer microphone 24 is disposed on the casing in a manner that permits acoustic coupling to the environment external to the casing.

In implementations that include ANR, the inner microphone 18 may be a feedback microphone and the outer microphone 24 may be a feedforward microphone. In such implementations, each earphone 12 includes an ANR circuit 26 that is in communication with the inner and outer microphones 18 and 24. The ANR circuit 26 receives an inner signal generated by the inner microphone 18 and an outer signal generated by the outer microphone 24 and performs an ANR process for the corresponding earpiece 12. The process includes providing a signal to an electroacoustic transducer (e.g., speaker) 28 disposed in the cavity 16 to generate an anti-noise acoustic signal that reduces or substantially prevents sound from one or more acoustic noise sources that are external to the earphone 12 from being heard by the user. As described herein, in addition to providing an anti-noise acoustic signal, electroacoustic transducer 28 can utilize its sound-radiating surface for providing an audio output for playback, e.g., for a continuous audio feed.

A control circuit 30 is in communication with the inner microphones 18, outer microphones 24, and electroacoustic transducers 28, and receives the inner and/or outer microphone signals. In certain examples, the control circuit 30 includes a microcontroller or processor having a digital signal processor (DSP), and the inner signals from the two inner microphones 18 and/or the outer signals from the two outer microphones 24 are converted to digital format by analog to digital converters. In response to the received inner and/or outer microphone signals, the control circuit 30 can take various actions. For example, audio playback may be initiated, paused or resumed, a notification to a user (e.g., wearer) may be provided or altered, and a device in communication with the personal audio device may be controlled. The audio device 10 also includes a power source 32. The control circuit 30 and power source 32 may be in one or both of the earpieces 12 or may be in a separate housing in communication with the earpieces 12. The audio device 10 may also include a network interface 34 to provide communication between the audio device 10 and one or more audio sources and other personal audio devices. The network interface 34 may be wired (e.g., Ethernet) or wireless (e.g., employ a wireless communication protocol such as IEEE 802.11, Bluetooth, Bluetooth Low Energy, or other local area network (LAN) or personal area network (PAN) protocols).

Network interface 34 is shown in phantom, as portions of the interface 34 may be located remotely from audio device 10. The network interface 34 can provide for communication between the audio device 10, audio sources and/or other networked (e.g., wireless) speaker packages and/or other audio playback devices via one or more communications protocols. The network interface 34 may provide either or both of a wireless interface and a wired interface. The wireless interface can allow the audio device 10 to communicate wirelessly with other devices in accordance with any communication protocol noted herein. In some particular cases, a wired interface can be used to provide network interface functions via a wired (e.g., Ethernet) connection.

Additional description of the control circuit 30 (e.g., including memory and processing function), network interface 34 (e.g., including network media processor functions) and other features of the audio device 10 can be found in U.S. patent application Ser. No. 16/179,205 (“Spatialized Virtual Personal Assistant”), filed on Nov. 2, 2018, which is herein incorporated by reference in its entirety.

As shown in FIG. 1, audio device 10 can also include a sensor system 36 coupled with control circuit 30 for detecting one or more conditions of the environment proximate audio device 10. Sensor system 36 can include inner microphones 18 and/or outer microphones 24, sensors for detecting inertial conditions at the audio device 10 and/or conditions of the environment proximate audio device 10 as described herein. The sensors may be on-board the audio device 10, or may be remote or otherwise wireless (or hard-wired) connected to the audio device 10. As described further herein, sensor system 36 can include a plurality of distinct sensor types for detecting inertial information, environmental information, or commands at the audio device 10. In particular implementations, sensor system 36 can enable detection of user movement, including movement of a user's head or other body part(s), and/or the look direction of a user. In particular, portions of sensor system 36 may incorporate one or more movement sensors, such as accelerometers gyroscopes and/or magnetometers. In some particular implementations, sensor system 36 can include a single inertial measurement unit (IMU) having three-dimensional (3D) accelerometers, gyroscopes and a magnetometer. Additionally, in various implementations, the sensor system 36 can include a barometer for detecting elevation via pressure readings. In some cases, the barometer can be useful in locating the audio device 10 vertically, e.g., in a tall building or underground.

In various implementations, the sensor system 36 can be located at the audio device 10, e.g., where an IMU is physically housed in the audio device 10. In some examples, the sensor system 36 (e.g., including the IMU) is configured to detect a position, or a change in position, of the audio device 10. This inertial information can be used to control various functions described herein. For example, the inertial information can be used to trigger a command function, such as activating an operating mode of the audio device 10 (e.g., AR audio mode), modify playback of an audio file, or suggest a distinct audio file for playback during an operating mode.

The sensor system 36 can also include one or more interface(s) for receiving commands at the audio device 10. For example, sensor system 36 can include an interface permitting a user to initiate functions of the audio device 10. In a particular example implementation, the sensor system 36 can include, or be coupled with, a capacitive touch interface for receiving tactile commands on the audio device 10.

In other implementations, as illustrated in the phantom depiction in FIG. 1, one or more portions of the sensor system 36 can be located at another device capable of indicating inertial, location, or other information about the user of the audio device 10. For example, in some cases, the sensor system 36 can include an IMU physically housed in a hand-held device such as a pointer, or in another wearable audio device. In particular example implementations, at least one of the sensors in the sensor system 36 can be housed in a wearable audio device distinct from the personal audio device 10, such as where audio device 10 includes headphones and an IMU is located in a pair of glasses, a watch or other wearable electronic device.

Data Flow

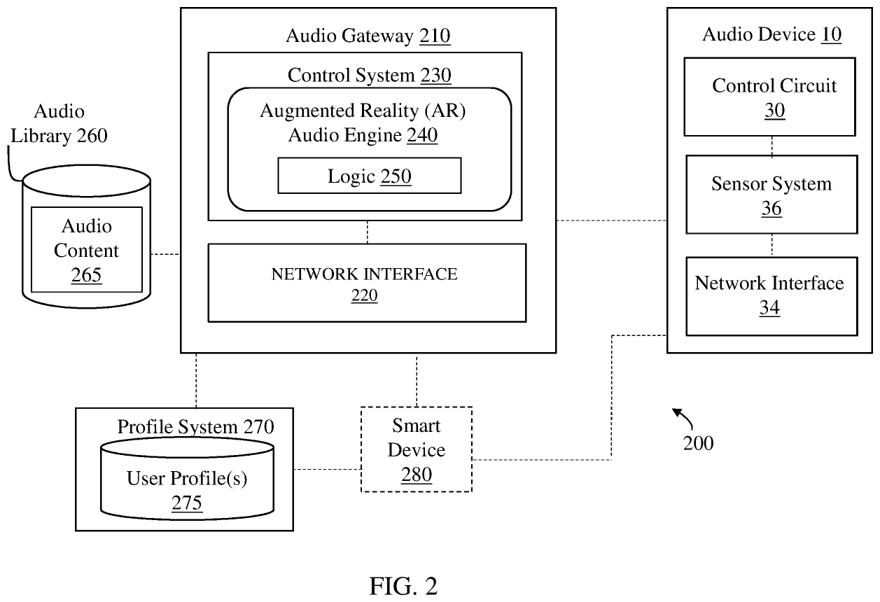

As described with respect to FIG. 1, control circuit 30 can execute (and in some cases store) instructions for controlling AR audio functions in audio device 10 and/or other audio playback devices in a network of such devices. FIG. 2 shows a schematic depiction of data flows in a system 200 including the personal audio device (or simply, audio device) 10 connected with an audio gateway device (audio gateway) 210. The audio device 10 and audio gateway 210 can be paired according to any connection described herein, e.g., a wireless connection such as Bluetooth, WiFi or Zigbee. Example configurations of an audio gateway 210 can include a cellular phone, personal data assistant (PDA), tablet, personal computer (PC), wearable communication system, or any other known audio gateway for providing audio content to audio device 10. In particular implementations, the audio gateway 210 includes a network interface 220, which can include similar network interface components as described with reference to the network interface 34 of audio device 10, e.g., a wireless transceiver configured to communicate over any wireless protocol described herein.

Audio gateway 210 can further include a control system 230 configured to execute control functions in the AR audio mode at the audio device 10. The control system 230 can include a microprocessor, memory, and other conventional control hardware/software for executing functions described herein. In some cases, control system 230 can include similar components as those described with respect to control circuit 30 in FIG. 1. In various implementations, control system 230 can have additional processing and/or storage capabilities not present at the control circuit 30 in audio device 10. However, in various implementations, actions performed by control system 230 can be executed at the control circuit 30 on audio device 10 to provide augmented reality (AR) audio functions described herein.

In particular implementations, control system 230 includes an augmented reality (AR) audio engine 240 or otherwise accesses program code for executing processes performed by AR audio engine 240 (e.g., via network interface 220). AR audio engine 240 can include logic 250 for executing functions described herein. Both audio gateway 210 and audio device 10 are shown in simplified form in FIG. 2 to focus illustration on functions described according to the AR audio engine 240. AR audio engine 240 can be configured to implement audio modifications in audio outputs at the transducer (e.g., speaker) 28 (FIG. 1) of the audio device 10 in response to receiving data indicating an AR audio playback condition is satisfied, and/or in response to receiving a command from a user (e.g., via one or more microphones in the sensor system 36 or in a paired smart device). In various particular embodiments, AR audio engine 240 is configured to receive data indicating that an AR audio playback condition is satisfied, and instruct the control circuit 30 at the audio device 10 to initiate playback of the AR audio at the transducer(s) 28 (FIG. 1). In particular cases, the AR audio is output at a spatially rendered audio location defined relative to the user's look direction or relative to a physical location proximate the user.

FIG. 2 illustrates data flows between components in system 200 (e.g., audio device 10 and audio gateway 210), as well as between those components and additional devices. It is understood that one or more components shown in the data flow diagram may be integrated in the same physical housing, e.g., in the housing of audio device 10, or may reside in one or more separate physical locations.

In particular implementations, the logic 250 in AR audio engine 240 is configured to process sensor data, contextual data, and/or user input data from the audio device 10 and/or additional sources (e.g., smart device 280, profile system 270, etc.) and execute various functions. For example, the AR audio engine 240 is configured to receive sensor data from the sensor system 36, data from one or more applications running at the audio gateway 210 and/or the smart device 280 and/or user profile data (e.g., from profile system 270). In various implementations, the AR audio engine 240 is also configured to receive commands from a user (e.g., via one or more interfaces and/or sensors described herein, such as interfaces and/or sensors in sensor system 36 and/or a separate smart device 280). In response to detecting that the AR audio playback condition is satisfied, the AR audio engine 240 can initiate playback (e.g., via transducer(s) 28 at audio device 10) of the AR audio. In particular cases, the AR audio is output at the audio device 10 in a spatially rendered audio location that is defined relative to a look direction of the user (e.g., the user's head direction or eye focus direction) or relative to a physical location proximate the user. In various implementations, the AR audio engine 240 outputs the AR audio according to an application setting, a location of the audio device 10, the look direction of the user, contextual information about what a user is doing, and/or a type of the playback condition data.

AR audio engine 240 (including logic 250, related software and/or hardware) can be located at the audio device 10, audio gateway 210 or any other device described herein (e.g., smart device 280). That is, AR audio engine 240 can be configured to execute functions at one or more devices and/or components described herein. In some cases, the AR audio engine 240 may take the form of an entirely hardware implementation, an entirely software implementation (including firmware, resident software, micro-code, etc.) or an implementation combining software and hardware aspects that may all generally be referred to herein as an “engine.” Additionally, the AR audio engine 240 may take the form of a computer program product embodied in any tangible medium of expression having computer-usable program code embodied in the medium. In various particular implementations, the AR audio engine 240 executes functions described herein according to logic 250, which can be stored or otherwise accessed by any device capable of performing those functions, e.g., audio gateway 210, audio device 10 or other device(s) described herein.

AR audio engine 240 can be coupled (e.g., wirelessly and/or via hardwired connections in personal audio device 10) with an audio library 260, which can include audio content 265 (e.g., audio file(s), playlist(s) of audio files, podcast(s), an audio stream or an Internet radio station, location-specific audio pins, condition-specific audio files and/or streams, or one or more audibly presented selections) for playback (e.g., streaming or otherwise rendering) at audio device 10 and/or a profile system 270 including user profiles 275 about one or more user(s). Audio library 260 can include any library associated with digital audio sources accessible via network interfaces 34 and/or 220 described herein, including locally stored, remotely stored or Internet-based audio libraries. While the audio library 260 and/or profile system 270 can be located at one or more remote devices, e.g., in a cloud-based system or at a remote storage device, it is understood that the audio library 260 and/or the profile system 270 could be integrated in any of the devices shown and described in FIG. 2, e.g., at the audio device 10, audio gateway 210 and/or smart device(s) 280.

In particular implementations, as noted herein, audio content 265 can include any audibly presentable material that can be provided to the user in response to detecting that one or more AR audio playback conditions is satisfied. As described herein, audio content 265 can include AR audio playback such as narrative audio, interactive audio, or a response to a command or a question. For example, narrative audio can include a brief file (or stream) that lasts a manner of seconds, and provides introductory, or narrative information about available AR audio playback. In some cases, narrative audio can include an introductory message, prompt or question that requests the user take action in order to trigger playback of a subsequent audio file (or audio stream), e.g.: “Would you like to hear about local restaurants in your area?”, “It seems that you are running; would you like to initiate your ‘running’ playlist?”, “Nod to hear your audio book”, or “Would you like to hear a music pin just dropped by Artist X?” Interactive audio can be assigned for playback following playback of the narrative audio. Examples of interactive audio files can include reviews of local restaurants (e.g., from a person followed on social media, or a celebrity), a playlist of music related to a particular detected activity (e.g., running, commuting, working), an audio book or podcast (e.g., related to the time of day, or a detected state of activity and/or location for the user), a recently released song from an artist known to be of interest to the user and/or a breaking news segment.

In certain cases, the narrative audio and/or the interactive audio includes a spatialized audio file configured for playback (which in some cases is binaural). In these cases, the spatialized audio file is configured for output at a spatially rendered audio location, or multiple spatially rendered audio locations, relative to the user. For example, the spatialized audio file can be configured for playback at one or more spatially rendered audio locations relative to the user's look direction (e.g., as detected by sensors at sensor system 36 and/or smart device 280), or relative to a physical location proximate the user. In other cases, the narrative audio and/or the interactive audio includes a monaural audio file, a stereo audio file, a spatialized audio file or a multichannel audio file. Application of spatialized audio functions in particular devices is further described in U.S. patent application Ser. No. 15/908,183, which is herein incorporated by reference in its entirety.

As noted herein, in various implementations, the audio content 265 can be settings-specific, location-specific, device-specific, time-specific, weather-specific, movement-specific, event-specific, specifically tailored to interaction with other users, or otherwise tailored to particular user experiences. In some cases, AR audio engine 240 presents audio content 265 to the user that is related to a particular location, e.g., when the user approaches that location, and can also present audio content 265 based upon the direction in which the user is facing (e.g., looking) (detected according to various implementations described herein). For example, looking straight ahead, left or right can trigger the AR audio engine 240 to provide audio content 265 (in a spatially rendered audio location defined relative to the different look direction) indicating areas of interest or other AR audio relevant to that look direction.

In some directionally-specific cases, the audio content 265 can include narrative audio such as introductory information about additional content associated with one or more look directions, e.g., as a sample. In the intersection example: a) when looking right (during operation of the AR audio mode), AR audio engine 240 can provide an audio sample such as: “Fenway Park is 0.5 miles from your current location in this direction; nod your head to hear highlights from last night's game”; b) when looking left (during operation of the AR audio mode), AR audio engine 240 can provide an audio sample such as: “Boston's Public Garden is 0.4 miles from your current location in this direction; tap your audio device to hear fun facts about this historic public gathering place”; and/or c) when looking straight ahead (during operation of the AR audio mode), AR audio engine 240 can provide an audio sample such as: “You are two blocks from Newbury Street; walk forward to hear a listing of top-rated restaurants for lunch.” It is understood that this example is merely illustrative of the various array layouts and audio sample types that can be utilized by AR audio engine 240 in AR audio mode. Various additional example implementations are described herein.

User profiles 275 may be user-specific, community-specific, device-specific, location-specific or otherwise associated with a particular entity such as the user. User profiles 275 can include user-defined playlists of digital music files, audio messages stored by the user of audio device 10, or another user, or other audio content available from network audio sources coupled with network interfaces 34 and/or 220, such as network-attached storage (NAS) devices, and/or a DLNA server, which may be accessible to the audio gateway 210 and/or audio device 10 over a local area network such as a wireless (e.g., Wi-Fi) or wired (e.g., Ethernet) home network, as well as Internet music services such as Pandora®, vTuner®, Spotify®, etc., which are accessible to the audio gateway 210 and/or audio device 10 over a wide area network such as the Internet. In some cases, profile system 270 is located in a local server, or a cloud-based server, similar to any such server described herein. User profile 275 may include information about frequently played audio content associated with the user of audio device 10 or other similar users (e.g., those with common audio content listening histories, demographic traits or Internet browsing histories), “liked” or otherwise favored audio content associated with the user or other similar users, frequency with which particular audio content is changed by the user or other similar users, etc. Profile system 270 can be associated with any community of users, e.g., a social network, subscription-based music service (such as a service providing audio library 260), and may include audio preferences, histories, etc. for the user as well as a plurality of other users. In particular implementations, profile system 270 can include user-specific preferences (as profiles 275) for messages and/or related notifications (e.g., prompts, audio overlays). Profiles 275 can be customized according to particular user preferences, or can be shared by users with common attributes.

As shown herein, AR audio engine 240 can also be coupled with a separate smart device 280. The smart device 280 is shown in phantom because it may be a separate component from the device executing the AR audio engine 240, however, it is understood that in various implementations, the audio gateway 210 is located at a smart device 280 (e.g., a smart phone, smart wearable device, etc.). The AR audio engine 240 can have access to a user profile (e.g., profile 275) and/or biometric information about the user of audio device 10. In some cases, the AR audio engine 240 directly accesses the user profile and biometric information, however, in other cases, the AR audio engine 240 can access the user profile and/or biometric information via a separate smart device 280. It is understood that smart device 280 can include one or more personal computing devices (e.g., desktop or laptop computer), wearable smart devices (e.g., smart watch, smart glasses), a smart phone, a remote control device, a smart beacon device (e.g., smart Bluetooth beacon system), a stationary speaker system, etc. Smart device 280 can include a conventional user interface for permitting interaction with a user, and can include one or more network interfaces for interacting with control circuit 30 and/or control system 230 and other components in audio device 10. However, as noted herein, in some cases the audio gateway 210 is located at a smart device such as the smart device 280.

In some example implementations, smart device 280 can be utilized for: connecting audio device 10 to a Wi-Fi network; creating a system account for the user; setting up music and/or location-based audio services; browsing of content for playback; setting preset assignments on the audio device 10 or other audio playback devices; transport control (e.g., play/pause, fast forward/rewind, etc.) for the audio device 10; and selecting one or more audio devices 10 for content playback (e.g., single room playback or synchronized multi-room playback). In some cases, smart device 280 may also be used for: music services setup; browsing of content; setting preset assignments on the audio playback devices; transport control of the audio playback devices; and selecting audio devices 10 (or other playback devices) for content playback. Smart device 280 can further include embedded sensors for measuring biometric information about a user, e.g., travel, sleep or exercise patterns; body temperature; heart rate; or pace of gait (e.g., via accelerometer(s)). In various implementations, one or more functions of the AR audio engine 240 can be executed at smart device 280. Further, it is understood that audio gateway 210 can include any manner of smart device described herein.

As described herein, AR audio engine 240 is configured to receive sensor data about one or more conditions at the audio device 10 from sensor system 36. In various particular implementations, the sensor system 36 can include an IMU for providing inertial information about the audio device 10 to the AR audio engine 240. In various implementations, this inertial information can include orientation, translation and heading. For example, inertial information can include changes in heading (e.g., from an absolute value relative to magnetic north), changes in orientation (e.g., roll, pitch, yaw), and absolute translation (e.g., changes in x-direction, y-direction, z-direction). Additionally, inertial information can include first and second derivatives (i.e., velocity and acceleration) of these parameters. In particular examples, the AR audio engine 240, including logic 250, is configured to calculate spatially rendered audio locations proximate the audio device for audio output using inputs such as audio pin angle, IMU azimuth angle and persistent azimuth, as described in U.S. patent application Ser. No. 15/908,183, which is hereby incorporated by reference in its entirety.

In additional implementations, sensor system 36 can include additional sensors for detecting conditions at the audio device, for example: a position tracking system; and a microphone (e.g., including one or more microphones). It is understood that any number of additional sensors can be incorporated in sensor system 36, and can include temperature sensors or humidity sensors for detecting changes in weather within environments, physiological sensors for detecting physiological conditions of the user (e.g., one or more biometric sensors such as a heart rate sensor, a photoplethysmogram (PPG), electroencephalogram (EEG), electrocardiogram (ECG) or EGO) optical/laser-based sensors and/or vision systems for tracking movement/speed/acceleration, light sensors for detecting time of day, additional audio sensors (e.g., microphones) for detecting human or other user speech or ambient noise, etc. These sensors are merely examples of sensor types that may be employed according to various implementations. It is further understood that sensor system 36 can deploy these sensors in distinct locations and distinct sub-components in order to detect particular environmental information relevant to user of audio device 10. Additional details about specific sensor types and functions, along with actuation mechanisms and cues in the audio device 10 and/or smart device 280 can be found in U.S. patent application Ser. No. 16/179,205 (“Spatialized Virtual Personal Assistant”), previously incorporated by reference herein.

In additional implementations, the AR audio engine 240 can alternatively (or additionally) be configured to implement modifications in audio outputs at the transducer (e.g., speaker) 28 (FIG. 1) at audio device 10 in response to receiving additional information from audio device 10 or another connected device such as audio gateway 210 and/or smart device 280. For example, a Bluetooth beacon (e.g., BLE beacon) trigger, GPS location trigger or timer/alarm mechanism can be used to initiate the AR audio mode at audio device 10. These triggers and mechanisms can be used in conjunction with other actuation mechanisms described herein (e.g., application data-based actuation, timing-based actuation, weather data-based actuation, voice actuation, gesture actuation, tactile actuation) to initiate the AR audio mode. In some cases, the AR audio mode can be initiated based upon proximity to a detected BLE beacon or GPS location. In other particular cases, the AR audio mode can be initiated based upon a timing mechanism, such as at particular times or intervals.

As additionally noted herein, the AR audio engine 240 can be configured to detect or otherwise retrieve contextual data about the user and/or usage of the audio device 10. For example, the AR audio engine 240 can be configured to retrieve contextual data from one or more applications running at the audio gateway 210 and/or the audio device 10, such as a calendar or organizational application, e-mail or messaging application, social media application, travel application, shopping application, fitness application, etc. The AR audio engine 240 can also be configured to detect that the user is engaging one or more device functions, for example, that the user is on a phone call or actively sending/receiving messages with another user using the audio gateway 210.

Example Process Flow

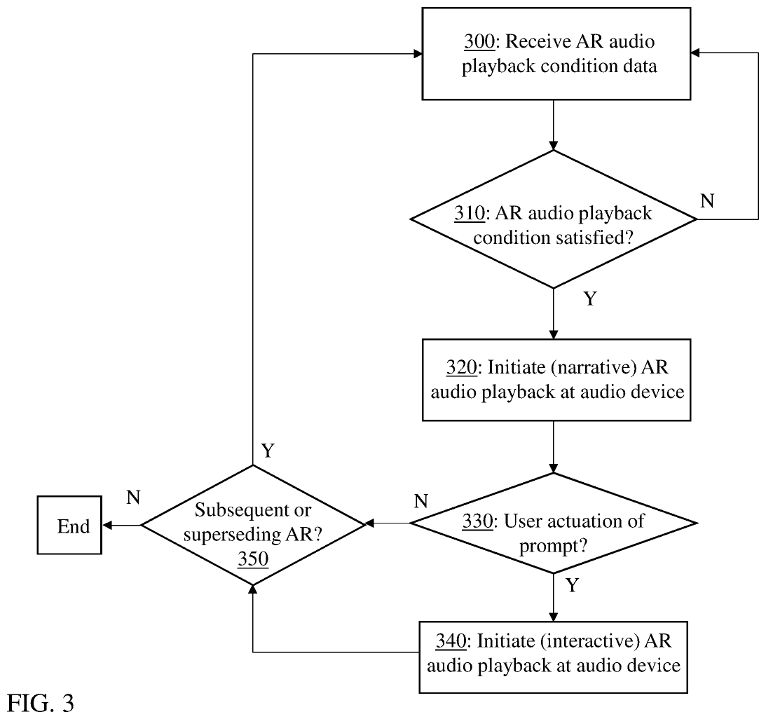

During operation, the AR audio engine 240 is configured to control playback of AR audio at the audio device 10 according to various playback conditions. In particular implementations, the AR audio engine 240 is configured to initiate playback of AR audio at the audio device in response to receiving data indicating an AR audio playback condition attributed to a user of the audio device 10 is satisfied. FIG. 3 illustrates a general process flow in controlling AR audio playback as performed by the AR audio engine 240. FIGS. 2 and 3 are referred to concurrently. As shown, in process 300, the AR audio engine 240 receives data relevant to one or more playback conditions. This data is then compared with AR audio playback condition data in order to determine whether a condition is satisfied (Decision 310). If an AR audio playback condition is not satisfied (No to Decision 310), the process can be repeated, e.g., as the AR audio engine 240 runs at the control system 230 (FIG. 1). That is, the AR audio engine 240 can be configured to continuously receive (or otherwise obtain) data about AR audio playback conditions, when enabled.

In various implementations, the AR audio engine 240 is executed as a software application configured to receive data from one or more systems and/or applications on the audio device 10, audio gateway 210 and/or smart device 280. As noted herein, the AR audio engine 240 can also access user profiles 275, which can include playback condition thresholds or other standards specific to the user. In some examples, the AR audio engine 240 can be configured to receive application execution data from an application running at the audio device 10, audio gateway 210 or the smart device 280. The application execution data can be received from one or more applications, e.g., a fitness application, a navigation application, a social media application, a news application, a streaming music application. The AR audio engine 240 can additionally, or alternatively, receive sensor data from the sensor system 36, e.g., IMU data, GPS data, voice signature data. The AR audio engine 240, in process 310, compares that application execution data and/or sensor data with a corresponding threshold (e.g., a value or a range) that is attributable to the user, a group of users including the users, or a default setting e.g., as stored in the user profile 275 or otherwise accessible through the AR audio engine 240.

In cases where the AR audio engine 240 detects that the AR audio playback condition is satisfied (Yes to decision 310), the AR audio engine 240 is configured to initiate playback of the AR audio at the audio device 10 (FIG. 1) in process 320. In various implementations, as described herein, AR audio can be played back as two distinct files (or streams), including a narrative audio file and an interactive audio file. In these cases, when the AR audio playback condition is satisfied, the AR audio engine 240 initiates playback of the narrative audio file (or stream) at the audio device 10, providing introductory information about the interactive audio file. In some examples, the AR audio playback includes the narrative audio file including a prompt to play the interactive audio file. Where the user actuates that prompt (e.g., via any voice, tactile, gesture or other response described herein, shown as Yes to decision 330), the AR audio engine 240 initiates playback of the interactive audio file (process 340).

In particular implementations, after, or during playback of the interactive audio file, the AR audio engine 240 checks to determine whether the user has settings (e.g., in profile(s) 275 or in other accessible settings) for permitting subsequent or superseding AR audio playback (decision 350). Where the user settings allow subsequent AR audio playback, after conclusion of the interactive audio file, the AR audio engine 240 is configured to revert back to process 300 and receive AR audio playback condition data from one or more sources. In the case of superseding AR audio, the AR audio engine 240 checks the user settings to determine whether a type of AR audio, or a source of the AR audio playback condition data, takes precedent over the currently playing interactive AR audio file. Where the settings permit superseding AR audio playback, the AR audio engine 240 can revert back to process 300 to receive additional AR audio playback condition data. In these cases, the AR audio engine 240 can be configured to perform a sub-process in decision 310, in that the AR audio engine 240 compares the AR audio playback condition data with a superseding playback condition threshold to determine whether the subsequently received AR audio playback condition data satisfies not only a playback condition threshold, but a superseding playback condition threshold. If satisfied, the process can continue as shown in FIG. 3, but with the superseding AR audio displacing the initial AR audio playback (e.g., via cut-out, fade in, audio mixing, etc.).

Returning to decision 330, where the user does not actuate that prompt, or responds in the negative to that prompt (No to Decision 330), the AR audio engine 240 can check additional settings (e.g., default settings or user profile settings) to determine whether subsequent or superseding AR is permitted (decision 350), as noted herein. In both portions of the flow diagram, where both subsequent and superseding AR audio are not enabled, the process can end.

In the above-described example, the option to designate superseding or subsequent AR audio playback in settings (e.g., profile settings or otherwise accessible settings for the AR audio engine 240), may allow the user to control unwanted intrusions from the audio device 10. That is, the user can define settings to tailor AR audio according to his/her lifestyle and desire for interactive audio experiences. While certain users may wish to receive information (e.g., notifications or prompts) related to a number of playback conditions, other users may define settings that prevent frequent or lower-priority notifications or prompts in order to avoid interrupting playback of the current AR audio at the audio device 10.

Geographic Location-Independent Examples

Various implementations described with reference to the flow diagram in FIG. 3 involve determining whether received data satisfies an AR audio playback condition. In some particular examples, the AR audio playback condition is independent of a detected geographic location of the audio device 10. That is, received data that satisfies the AR audio playback condition will not vary based upon the detected geographic location of the audio device 10. These approaches differ from some geo-location based audio playback systems, that allow users to locate (or “drop”) an audio pin at a specific geographic location to trigger audio playback by one or more users when those users are physically present at the geographic location. In contrast, the AR audio playback conditions described according to various implementations can be satisfied without data indicating the specific geographic location of the audio device (e.g., geo-location data). Examples of geographic location independent conditions can include:

A) Clock data indicating a current time of day. In various implementations, the AR audio engine 240 is configured to receive clock data indicating the current time of day. This clock data can be retrieved from a clock or timing mechanism at the audio device 10, audio gateway 210 and/or smart device 280, and as with any other data described with reference to the AR audio engine 240 herein, can be retrieved on-demand or on a periodic basis. In various implementations, the AR audio engine 240 is configured to vary the AR audio based upon the indicated current time of day (from the received clock data). For example, the AR audio engine 240 can be configured to receive clock data from one or more systems, compare that clock data with a stored AR audio condition threshold for the user, and notify the user that AR audio related to the time of day indicated by the clock data (e.g., morning, afternoon, evening, rush hour, dinner hour, etc.) is available for playback. In some cases, the AR audio engine 240 is configured to play a narrative audio file to notify the user that particular AR audio is available for playback in response to detecting that a clock data condition is met (e.g., clock data coincides with threshold). As described herein, the AR audio engine 240 is further configured to play an interactive audio file in response to user actuation of a prompt during or after playback of the narrative audio file. In some examples, the user (or default settings at the AR audio engine 240) can define an AR audio playback condition for a particular time of day in order to play music relevant to that time of day. In a particular example, the user can define an AR audio playback condition for bedtime (e.g., 9:00 PM or 10:00 PM), and in response to detecting that the time meets this condition (e.g., from clock data), the AR audio engine 240 initiates the AR audio playback at the audio device 10.

B) Weather data indicating a weather condition proximate the audio device 10, such that the AR audio engine is configured to vary the AR audio based upon the detected weather condition. In various implementations, the AR audio engine 240 is configured to receive weather data from one or more sensors 36 and/or a weather application running on one of the system devices (e.g., audio device 10, audio gateway 210 and/or smart device 280). Sensors 36 can include, for example, humidity sensors to detect humidity or rain, microphones to detect rain or sleet, or temperature sensors to detect ambient temperature. In any case, the AR audio engine 240 is configured to receive weather data about the weather condition proximate the audio device 10, and when that weather data indicates that an AR audio playback condition is satisfied, initiate playback of the AR audio at the audio device 10. In some particular examples, a user can define a “rainy day” playlist, which includes songs about rain, mellow music or other audio content for playback during rainy weather conditions. In other cases, a user can define a warm or hot-weather playlist such as music or other audio content related to the summer season or the beach. In still other cases, the AR audio playback condition can be related to changes in weather condition, such that the AR audio engine 240 initiates playback of the AR audio in response to detecting that a change in weather is occurring or is occurring in the near future (e.g., from a forecasting function in a weather application). In these cases, the AR audio engine 240 can be configured to prompt the user to hear an audio forecast of the weather conditions, e.g., in the coming hours or days.

C) Speed or acceleration data indicating a speed at which the audio device 10 is moving or a rate of acceleration for the audio device 10, such that the AR audio engine 240 is configured to vary the AR audio based upon the indicated speed/acceleration of the audio device 10. In these cases, the AR audio engine 240 can detect an approximate speed or rate of acceleration for the audio device 10, and when that speed/acceleration meets the AR audio playback condition threshold, initiate playback of the AR audio. Speed and/or acceleration can be detected using the sensors 36 described with respect to FIGS. 1 and 2, e.g., IMU, accelerometer(s), optical sensors, etc. In some particular examples, the AR audio playback condition can be used to enhance exercise or other fast-paced activity, and the AR audio engine 240 is configured to receive speed/acceleration data in order to initiate motivating AR audio playback for the user. For example, the AR audio engine 240 can be configured to receive data indicating that the audio device 10 is accelerating at equal to or greater than a threshold rate or maintaining a speed that is equal to or greater than a threshold speed, and initiate playback of a narrative audio file including a voice prompt such as: “It seems you are jogging or biking; double-tap to play your ‘jogging’ playlist or nod to pick up the last played session in your ‘bicycle coach’ application.” In response to user actuation of one of the prompts, the AR audio engine 240 can play back the selected audio file(s)/stream(s).

D) Relative location data indicating the audio device 10 is proximate to a plurality of additional audio devices associated with corresponding users (e.g., executing a common application on the audio device 10 or audio gateway 210). In these cases, while location is relevant to controlling AR audio playback, it is relative location and not specific geographic location that dictates the nature of the playback. For example, the AR audio engine 240 can be configured to receive data from one or more additional audio devices (similar to audio device 10, FIGS. 1 and 2) that are in communication with the audio device 10 about the proximity of those additional devices in a given perimeter. In some cases, the AR audio engine 240 detects that the additional audio devices are within a certain radius (e.g., using BLE connection availability), or that the additional audio devices are on a shared local connection (e.g., a Wi-Fi network) that implies proximity. In particular implementations, the AR audio engine 240 is configured to initiate AR audio playback only in response to detecting a threshold number of additional users are within a threshold proximity of the audio device 10. In these cases, the AR audio engine 240 can enhance the social aspects of the audio device 10 by enabling a few or more people to participate in communications, games, or other collaborative events. In various implementations, the AR audio engine 240 is configured to analyze potential connections from proximate devices (e.g., within BLE communication range, Wi-Fi range, or other geographic perimeter as defined by location-based application(s)), and in response to detecting that a threshold number of additional users (e.g., two or more) running the AR audio engine 240 on their devices are within this range, can play back a narrative audio file to initiate communication/interaction with these additional users. For example, the AR audio engine 240 can play back a narrative audio file such as: “There are multiple additional players of Scavenger Hunt located in this area right now; would you like to initiate a hunt?” or “Several people in this area are actively using Dating Application X, would you like to initiate a group date to break the ice?”. In various implementations, logic in the application (e.g., AR audio engine 240) controls interaction between a plurality of audio devices associated with different users. In various implementations, the application running at a server (e.g., cloud-based server) can identify users within a geographic perimeter, based upon relative location, in order to enable communications, games, collaborative events, etc.

E) Detecting proximity of an additional audio device associated with an additional user executing a common application (e.g., AR audio engine 240) on his/her audio device or a paired audio gateway; and prompting the user to initiate peer-to-peer (P2P) communication with the additional user based upon that detection. While this process can be similar to the group communication/gaming/social interaction described in example (D), in this case, P2P communication is enabled between only two users. In these cases, the AR audio engine 240 need only detect that an additional user running the AR audio engine 240 on his/her device(s) is within P2P communication range, and after making that determination, initiates playback of a narrative audio file at the audio device 10 to prompt the user regarding this potential connection. For example, the AR audio engine 240 can detect the proximity of the additional user (e.g., via range finding P2P functions such as BLE range, near-field ID range, RFID range), and prompt the user with a narrative audio file including: “Would you like to establish a P2P connection with nearby user John, who is in this café right now?”

F) Celestial event data indicating a current or impending celestial event. In these cases, the AR audio engine 240 is configured to receive data indicating a currently occurring or impending celestial event, e.g., a full moon, a solar or lunar eclipse, a meteor shower, a shooting star, etc. In some cases, the AR audio engine 240 receives celestial event data from a weather application running on the audio device 10, audio gateway 210 and/or smart device 280 (FIG. 2), and in response to receiving that celestial event data, prompts the user to hear AR audio related to that event. For example, the AR audio engine 240 can be configured to play back AR audio that describes the celestial event (e.g., “Tonight's lunar eclipse occurs no more than three times per year, and in your hemisphere, is difficult to see with the naked eye all but once per year”, or “If you look outside within the next twenty minutes, you are likely to see a meteor shower in the southern portion of the sky”). In some optional implementations, the AR audio engine 240 pulls weather data from the weather application running on the user's device(s), and checks this weather data against location data about the audio device 10 in order to determine whether the celestial event is being experienced in the user's current location.

G) Current event data indicating a breaking news story, a new release of a product, or a new release of an artistic work. In these cases, the AR audio engine 240 is configured to receive current event data from one or more additional applications running on the audio device 10, audio gateway 210 and/or smart device 280 (FIG. 2), for example, a news application, a social media application where the user follows a particular company (e.g., Bose Corporation) or an artist (e.g., Lady Gaga). The AR audio engine 240 is configured to receive current event data (e.g., via a push notification) and in response receiving that data, initiate playback of AR audio such as a narrative audio file about the current event. For example, the AR audio engine 240 can receive current event data from a social media application where the user has an account and has designated settings to follow the Bose Corporation. In this example, the Bose Corporation could announce a new product such as the Bose Frames audio sunglasses, and the AR audio engine 240 would receive the current event data about this new product via the social media application. The AR Audio engine 240 can then notify the user, for example, with a narrative audio file played at the audio device (e.g., “Bose just announced a great new wearable audio product; would you like to find your nearest Bose store to experience a demo?”). In other examples, the AR audio engine 240 can receive current event data from a news application (e.g., CNN, NBC, Fox), and based upon the user's preferences in his/her profile 275 (FIG. 2), can notify the user of the event (e.g., “A trade agreement was signed today between the US and the EU; would you like to hear the full story?”).

H) Application execution data for an application executing on the audio device 10 (or gateway 210), where the application provides in-experience voting or polling. In these cases, the AR audio engine 240 is configured to provide AR playback including a voting question or a polling question including a request for feedback from the user. In these cases, the application can include a voting or polling application, such as those run by professional polling organizations, political conventions or action committees. In still other cases, the application can include a voting or polling application related to a social media application or a company interested in feedback about goods or services. In any case, the application can be configured to detect a polling or voting condition (e.g., based upon a time period or a local time such as a poll that opens at 1:00 PM and lasts for 30 seconds or a minute to enable user response), and send data to the AR audio engine 240 to indicate the polling or voting condition. Based upon user settings permitting the polling question or voting mechanism, the AR audio engine 240 is configured to play a narrative audio file at the audio device 10, such as: “Nod to answer a polling question about your experience at Restaurant X today” or “Double-tap to vote on your favorite character from Movie Z that you just watched”. If the user actuates a prompt (e.g., nod or double-tap) related to the narrative audio file, the AR audio engine 240 is configured to initiate playback of an interactive audio file with additional detail about the polling question or vote, such as: “Please look left and nod to vote negatively about your meal today, look right and nod to vote positively about your meal today, or say “neutral” to vote neutrally about your meal today.” In the movie example, after actuation of the prompt from the narrative audio file, the AR audio engine 240 can play an interactive audio file such as: “Please nod when you hear your favorite character's name . . . Villain 1 . . . Hero 2 . . . Jester.”

Partially Location-Dependent Examples

As noted herein, various implementations utilize location-independent AR audio playback conditions in order to control the AR audio experience. The following examples describe AR audio playback conditions that partially rely upon a known location of the audio device 10, but may not be directly connected with a particular geographic location.

I) Location pattern data about a common travel pattern for the user. In these cases, the AR audio engine 240 is configured to detect that the audio device 10 (and implicitly, the user) is travelling along a common travel pattern. For example, the AR audio engine 240 can receive location pattern data from a travel application or other location tracking application running on the audio device 10, audio gateway 210 and/or smart device 280 that indicates the audio device 10 is at a location associated with a common travel pattern for the user. For example, the travel or location-based application can detect that the user walks to the same train station on weekdays to commute to his/her office. This application can detect locations along that travel pattern (e.g., travel route), and when the audio device 10 intersects one or more of those locations, can send a notification to the AR audio engine 240 indicating that the user is possibly on a common travel pattern. In various implementations, the AR audio engine 240 can wait to receive at least two indications from the travel/location application that the user is traveling according to a common pattern before taking action, e.g., before initiating AR audio playback at the audio device 10. In this sense, the AR audio engine 240 can prevent false positives and reduce the number of notifications that the user receives for travel pattern related AR audio. In various implementations, in response to receiving two, three or more indications from the travel/location application that the audio device 10 is travelling along a common travel pattern, the AR audio engine 240 initiates AR audio playback relevant to that travel pattern at the audio device 10. For example, the AR audio engine 240 can initiate playback of a narrative audio file, such as: “It seems as though you are heading to the office; would you like to pick up your audio book where you left off last night?” or “It seems you are on your usual bike path; would you like to play your ‘biking’ playlist?).

II) Location pattern data about a popular travel pattern for a group of users. This approach may utilize travel and/or location pattern data for a plurality of users, such as where the user is located at a highly trafficked location and can experience AR audio relevant to that location. In these cases, the AR audio engine 240 can store or otherwise access data indicating that a location is on a popular travel route or pattern, e.g., a location on the Freedom Trail in Boston, or a public transit stop such as the Fenway or Yawkey stops near Fenway Park in Boston. Where the AR audio engine 240 detects that that the audio device 10 intersects a location on this popular travel route (e.g., via location application, GPS data, or other location tracking described herein), the AR audio engine 240 can play a narrative audio file at the audio device 10 to describe the travel route, or to suggest that the user travel along points on that route. The narrative audio file can include a prompt to begin a game or complete a task, or to take a tour (e.g., “Nod to hear information about the Boston Red Sox and take a walking tour around Fenway Park”, or “Double-tap to begin a scavenger hunt saved by User X along this route”). In various examples, the popular travel route can include a tour route (e.g., a tour of a neighborhood or a city), a multi-version route such as one tied to a choose-your-own adventure game, a Zombie Run or other point-to-point conditionality game/route.

III) Location type data indicating a type of geographic location proximate the audio device 10. In these cases, the AR audio engine 240 is configured to receive data about a type of geographic location proximate the audio device 10, and when that data satisfies the geographic location type condition, initiate playback of the AR audio at the audio device 10. In some cases, the user can designate particular AR audio or categories of AR audio based upon the indicated type of geographic location. For example, the user can designate particular AR audio for greenspace-type locations (e.g., parks, fields, etc.), and designate distinct AR audio for urban locations (e.g., city streets). The user can designate AR audio according to activities associated with particular location types, for example, the user may associate greenspaces with yoga or meditation, and designate calming AR audio playback for such locations. In the example of urban locations, the user may prefer to hear up-tempo music when walking through city streets. In still other examples, the AR audio engine 240 can receive application execution data about one or more other services or offerings proximate the location, and prompt the user to hear about those services or offerings (e.g., “It seems you are trying to hail a car to drive across town. There is currently heavy automobile traffic going in that direction. You are in a location that is densely populated with electric scooters and bicycles, as well as nearby to a subway station. Nod to hear about electric scooter options; single tap to hear about bicycle options; double-tap to hear about subway lines and schedules.”).

IV) Demographic data indicating at least one demographic attribute of the geographic location proximate the audio device 10. In various implementations, the demographic attribute of the geographic location is accessible from a social media application, census data, or user-provided profile data for one or more applications connected with the AR audio engine 240 (such as those running on the audio gateway 210 or smart device 280). In some cases, where the AR audio engine 240 receives demographic data about a demographic attribute of a geographic location, the AR audio engine 240 can initiate AR audio playback at the audio device 10 including audio tailored to that demographic attribute. For example, where the demographic data indicates that a neighborhood in Boston has a high percentage of Italian-born or Italian-American residents, the AR audio engine 240 can prompt the user with a narrative audio file to hear about the history of the neighborhood and how immigration shaped the area (e.g., “This is the North End neighborhood of Boston; would you like to hear about the history of this neighborhood as told by residents through the years?”). In another area where the demographic data indicates that a neighborhood in New York City has many Indian-born or Indian-American residents, the AR audio engine 240 can prompt the user with a narrative audio file to hear traditional Indian music (e.g., “Nod to hear a song performed by the legendary sitar player, Ravi Shankar”) or restaurant information from local Indian chefs (e.g., “Nod to hear about Northern Indian cuisine prepared by the owner/operator/chef at Restaurant X”). As noted herein, the AR audio engine 240 can be configured to initiate playback of distinct AR audio based upon the demographic attribute(s) of the indicated geographic location.

V) Social media data indicating a social media connection with another user of a social media platform, where the current geographic location of the audio device 10 is proximate to a geographic location having an audio pin related to the other user of the social media platform. In these cases, the AR audio engine 240 is configured to receive (or otherwise obtain) data from the social media application that an audio pin left at a geographic location is related to another user in the audio device user's social media network (e.g., a social media connection such as a friend or co-worker). In response to detecting the audio pin in the location proximate the audio device 10, the AR audio engine 240 checks to see if any of the user's social media connections are user(s) associated with the pin (e.g., a user that “dropped” the pin, or user(s) that “liked” or otherwise endorsed the pin). In the case that the social media connection is a user associated with the pin (in proximity to the audio device 10), the AR audio engine 240 is configured to play a narrative audio file to prompt the user to listen to the audio pin (e.g., “Taylor Swift left an audio pin nearby; double-tap to listen”, or “Your friend, Utsav, recently ate at a restaurant in this neighborhood; nod to hear her review”).

Additional AR Audio Functions

In various implementations, as noted herein, the AR audio engine 240 is configured to prioritize AR audio according to one or more rules, e.g., user-defined rules for prioritizing one or more types of AR audio or types of AR audio conditions over others, limiting a number of AR audio interruptions in a given period or within a given geographic range and/or limiting interruptions when multiple AR audio options are available. These user-defined preferences can be referred to as “tags” in some cases. While the AR audio engine 240 is configured to provide responsive, immersive audio experiences in a variety of environments, the AR audio engine 240 is also configurable to minimize intrusion into the user's other auditory experiences.

In some implementations the AR audio engine 240 is described as providing prompts to the user in order to execute particular device functions. It is understood that in various implementations, the AR audio engine 240 can also be configured to receive commands or questions from the user in order to initiate AR audio playback at the audio device 10. For example, in the case of social media connections (Partially Location-Dependent Examples; V), the user can initiate the AR audio engine 240 by asking a question (e.g., “Have any of my friends eaten nearby?”), to which the AR audio engine 240 responds with a narrative audio file (e.g., “Yes, Charlie had dinner two blocks away last weekend; would you like to hear his review?”).

In some additional implementations, the AR audio engine 240 is configured to control additional device functions at the audio device 10 in order to provide an immersive AR audio experience. For example, in some cases, the AR audio engine 240 is configured to activate a noise canceling function (e.g., via ANR circuit 26) on the audio device 10 during playback of the AR audio. In some cases, the AR audio engine 240 is configured to activate noise canceling functions based upon settings defined by the user or settings defined by a provider of content in the AR audio. In these cases, the user can define settings (e.g., via profile 275, FIG. 2) for noise cancelling, such that he/she may request ANR for playback in an area where the ambient noise level exceeds a threshold, or where a particular type of audio is played back (e.g., music versus audio book versus podcast). The AR audio engine 240 is configured to activate the ANR circuit 26 to cancel ambient noise according to these settings. Controllable Noise Cancelling (CNC) functions (e.g., adjusting the level of noise cancellation) can be similarly enabled from the user's perspective.

In other cases, the AR content provider can define default ANR settings for playback of content, e.g., to provide a more immersive experience for the user. In these cases, the AR content provider could include a commercial entity such as a concert venue or a retail store. When the user passes the concert venue or the retail store and the AR audio engine 240 initiates AR audio playback provided by the concert venue or the retail store (e.g., an offer to list upcoming concerts, or an offer to describe promotional pricing on retail goods) at the audio device 10, that content can include instructions for engaging the ANR circuit 26 to cancel ambient noise during the playback. These features can be initially designated at a default setting allowing the content provider to define the ANR level, but allow the user to adjust those settings for his/her preferences. In some cases, this ANR feature can enhance the appeal of the AR audio engine 240 to content providers, for example to those content providers wishing to capture the user's maximum attention while providing content.

In still further implementations, the user profile 275 (FIG. 2) and/or data stored or otherwise accessible by the AR audio engine 240 can include AR audio playback data attributed to the user and a geographic location in order to prevent playback of AR audio that was previously deprioritized by the user. In these cases, the AR audio playback data can indicate which file(s)/stream(s) the user previously listened to and disliked, skipped or otherwise deprioritized. These features may be beneficial when a user frequents a particular geographic location and is likely to trigger the same AR audio playback conditions.

In additional implementations, the AR audio engine 240 is configured to detect information about the capabilities of the audio device 10, and tailor the selection options for the narrative audio file and/or the interactive audio file accordingly. That is, where the AR audio engine 240 detects that the audio device 10 is a head or shoulder-worn speaker system that can benefit from binaural playback, the AR audio engine 240 can filter AR audio options to include spatialized audio files. In other cases, where the AR audio engine 240 detects that the audio device 10 is a portable speaker system that may not benefit from binaural playback, the AR audio engine 240 can filter AR audio options to exclude spatialized audio files, or prioritize monaural audio files, stereo audio files or multichannel audio files.

In particular cases, the interactive audio file that is played in response to actuation of the narrative audio file can include a plurality of interactive audio sub-files for rendering playback based upon an orientation of the user of audio device 10 (FIG. 1). That is, the AR audio engine 240 can be configured to play back distinct interactive audio files at the audio device 10 based upon the orientation of the user. In certain cases, the orientation of the user is determined based upon a look direction of the user while wearing the audio device 10 (e.g., based upon sensor data such as inertial measurement unit (IMU) data, optical sensor data, etc.). These sub-files can be assigned based upon an orientation of the user 110 at a given location. For example, with relative north (N) as a reference point, the sub-files can be assigned to orientations defined by degrees from N at a given location. In a particular example, a first sub-file A is assigned to degrees 1-90 (in the clockwise direction), a second sub-file B is assigned to a degrees 91-180, a third sub-file C is assigned to degrees 181-270, and a fourth sub-file D is assigned to degrees 271-360.

In particular implementations, the AR audio engine 240 is managed via an application programming interface (API) that permits software developers to build a framework of augmented reality audio to enhance user experiences. The API allows a software developer to enter file selection inputs for particular location-based AR audio, which can include a plurality of (e.g., two or more) sub-inputs used for orientation-based playback. In these cases, prior to rendering the interactive audio file at the audio device 10, the AR audio engine 240 can further detect an orientation of the user (or, the audio device 10) in response to actuation of the narrative audio file prompt, and render one of the plurality of sub-inputs based upon the detected orientation. In these cases, the user can experience distinct playback while at the same physical location, based upon differences in orientation. In certain cases, orientation can include additional dimensional considerations, for example, elevation, such that sub-inputs can be assigned to a same general physical location based upon differences in elevation, as well as look direction. Additional details and examples related to the user experience in the augmented audio environment are described in the following patent applications, each of which is herein incorporated by reference in its entirety: U.S. patent application Ser. No. 16/267,643 (“Location-Based Personal Audio”); U.S. patent application Ser. No. 16/179,205 (“Spatialized Virtual Personal Assistant”); and US patent application Ser. No. ______ (Docket No. OG-19-138-US, entitled “Augmented Audio Development”), filed concurrently herewith on ______.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit). Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

In various implementations, electronic components described as being “coupled” can be linked via conventional hard-wired and/or wireless means such that these electronic components can communicate data with one another. Additionally, sub-components within a given component can be considered to be linked via conventional pathways, which may not necessarily be illustrated.

A number of implementations have been described. Nevertheless, it will be understood that additional modifications may be made without departing from the scope of the inventive concepts described herein, and, accordingly, other embodiments are within the scope of the following claims.

1. A computer-implemented method of controlling playback of augmented reality (AR) audio at a wearable audio device, the method comprising:
receiving data indicating an AR audio playback condition attributed to a user of the wearable audio device is satisfied, wherein the AR audio playback condition is independent of a detected geographic location of the wearable audio device; and
initiating playback of the AR audio at the wearable audio device in response to receiving the data indicating that the AR audio playback condition is satisfied, wherein initiating playback of the AR audio comprises:
initiating playback of a narrative audio file that provides introductory information about an interactive audio file, wherein the narrative audio file comprises a prompt to play the interactive audio file; and
initiating playback of the interactive audio file in response to actuation of the prompt.

2. The computer-implemented method of claim 1, wherein the data indicating the AR audio playback condition is satisfied comprises:
clock data indicating a current time of day, wherein the AR audio differs based upon the indicated current time of day such that distinct narrative audio files are played in response to receiving the data indicating that the AR audio playback condition is satisfied at distinct times of the day, or
weather data indicating a weather condition proximate the wearable audio device, wherein the AR audio differs based upon the indicated weather condition such that distinct narrative audio files are played in response to receiving the data indicating that the AR audio playback condition is satisfied while the weather data indicates distinct weather conditions proximate the wearable audio device.

3. (canceled)

4. The computer-implemented method of claim 1, wherein the data indicating the AR audio playback condition is satisfied comprises relative location data indicating the wearable audio device is proximate to a plurality of additional wearable audio devices associated with corresponding users executing a common application on the wearable audio device or a paired audio gateway, wherein the AR audio playback condition is satisfied only in response to detecting that a threshold number of additional users are located within a threshold proximity of the wearable audio device, wherein the threshold number of additional users is equal to at least two additional users.

5. The computer-implemented method of claim 1, wherein the data indicating the AR audio playback condition is satisfied comprises:
a) celestial event data indicating a current or impending celestial event,
b) current event data indicating a breaking news story, a new release of a product, or a new release of an artistic work, or
c) speed or acceleration data indicating a speed at which the wearable audio device is moving or a rate of acceleration for the wearable audio device, wherein the AR audio differs based upon the indicated speed or rate of acceleration.

6. (canceled)

7. The computer-implemented method of claim 1, further comprising activating a noise canceling function on the wearable audio device during the playback of the AR audio, wherein the noise canceling function is based upon settings defined by the user or settings defined by a provider of content in the AR audio.

8. (canceled)

9. The computer-implemented method of claim 1, further comprising:
detecting proximity of an additional wearable audio device associated with an additional user executing a common application on the wearable audio device or a paired audio gateway; and
prompting the user to initiate peer-to-peer (P2P) communication with the additional user in response to detecting the proximity of the additional wearable audio device to the wearable audio device.

10. The computer-implemented method of claim 1, wherein the data indicating the AR audio playback condition is satisfied comprises application execution data for an application executing on the wearable audio device or a paired audio gateway, the application providing in-experience voting or polling, wherein the AR playback comprises:
playback of the narrative audio file introducing a voting or polling process and comprising the prompt to play the interactive audio file, and
in response to actuation of the prompt, playback of the interactive audio file comprising a voting question or a polling question comprising a request for feedback from the user.

11. A wearable audio device comprising:
an acoustic transducer having a sound-radiating surface for providing an audio output; and
a control system coupled with the acoustic transducer, the control system configured to:
receive data indicating an AR audio playback condition attributed to a user of the wearable audio device is satisfied, wherein the AR audio playback condition is independent of a detected geographic location of the wearable audio device; and
initiate playback of AR audio at the acoustic transducer in response to receiving the data indicating that the AR audio playback condition is satisfied wherein initiating playback of the AR audio comprises:
initiating playback of a narrative audio file that provides introductory information about an interactive audio file, wherein the narrative audio file comprises a prompt to play the interactive audio file; and
initiating playback of the interactive audio file in response to actuation of the prompt.

12. The wearable audio device of claim 11, wherein the data indicating the AR audio playback condition is satisfied comprises:
clock data indicating a current time of day, wherein the AR audio differs based upon the indicated current time of day such that distinct narrative audio files are played in response to receiving the data indicating that the AR audio playback condition is satisfied at distinct times of the day, or
weather data indicating a weather condition proximate the wearable audio device, wherein the AR audio differs based upon the indicated weather condition such that distinct narrative audio files are played in response to receiving the data indicating that the AR audio playback condition is satisfied while the weather data indicates distinct weather conditions proximate the wearable audio device.

13. The wearable audio device of claim 11, wherein the data indicating the AR audio playback condition is satisfied comprises:
a) speed data indicating a speed at which the wearable audio device is moving or a rate of acceleration for the wearable audio device, wherein the AR audio differs based upon the indicated speed or rate of acceleration,
b) celestial event data indicating a current or impending celestial event, or
c) current event data indicating a breaking news story, a new release of a product, or a new release of an artistic work.

14. The wearable audio device of claim 11, wherein the data indicating the AR audio playback condition is satisfied comprises relative location data indicating the wearable audio device is proximate to a plurality of additional wearable audio devices associated with corresponding users executing a common application on the wearable audio device or a paired audio gateway, wherein the AR audio playback condition is satisfied only in response to detecting that a threshold number of additional users are located within a threshold proximity of the wearable audio device, wherein the threshold number of additional users is equal to at least two additional users.

15. (canceled)

16. (canceled)

17. The wearable audio device of claim 11, further comprising an active noise reduction (ANR) circuit coupled with the control system, wherein the control system is configured to activate the ANR circuit during the playback of the AR audio, wherein activating the ANR circuit is based upon settings defined by the user or settings defined by a provider of content in the AR audio.

18. The wearable audio device of claim 11, wherein the control system is further configured to:
detect proximity of an additional wearable audio device associated with an additional user executing a common application on the wearable audio device or a paired audio gateway; and
prompt the user to initiate peer-to-peer (P2P) communication with the additional user in response to detecting the proximity of the additional wearable audio device to the wearable audio device.

19. The wearable audio device of claim 11, wherein the data indicating the AR audio playback condition is satisfied comprises application execution data for an application executing on the wearable audio device or a paired audio gateway, the application providing in-experience voting or polling, wherein the AR playback comprises:
playback of the narrative audio file introducing a voting or polling process and comprising the prompt to play the interactive file, and
in response to actuation of the prompt, playback of the interactive audio file comprising a voting question or a polling question comprising a request for feedback from the user.

20. A computer-implemented method of controlling playback of augmented reality (AR) audio at a wearable audio device, the method comprising:
receiving data indicating an AR audio playback condition attributed to a user of the wearable audio device is satisfied, wherein the data indicating the AR audio playback condition is satisfied comprises at least one of:
location pattern data about a common travel pattern for the user, wherein the location pattern data indicates that a current geographic location of the wearable audio device is associated with the common travel pattern for the user, or
location pattern data about a popular travel pattern for a group of users, wherein the location pattern data indicates that the current geographic location of the wearable audio device is on the popular travel pattern,
wherein the common travel pattern for the user or the popular travel pattern intersects the current geographic location of the wearable audio device; and
initiating playback of the AR audio at the wearable audio device in response to receiving the data indicating that the AR audio playback condition is satisfied.

21. The computer-implemented method of claim 20, wherein the data indicating the AR audio playback condition is satisfied comprises the location pattern data about the common travel pattern for the user, wherein initiating the playback of the AR audio file is performed only in response to detecting that the wearable audio device intersects at least two distinct geographic locations associated with the common travel pattern for the user.

22. The computer-implemented method of claim 20, wherein the data indicating the AR audio playback condition is satisfied comprises the location pattern data about the popular travel pattern for the group of users, wherein initiating playback of the AR audio comprises:
initiating playback of a narrative audio file that provides introductory information about the popular travel pattern, wherein the narrative audio file comprises a prompt to play an interactive audio file that provides information about additional locations in the popular travel pattern; and
initiating playback of the interactive audio file in response to actuation of the prompt.

23. The computer-implemented method of claim 1, further comprising:
after or during playback of the interactive audio file, checking to determine whether settings attributed to the user permit subsequent AR audio playback; and
in response to: the settings attributed to the user allowing subsequent AR audio playback, and conclusion of playback of the interactive audio file:
receiving data indicating an additional AR audio playback condition attributed to the user of the wearable audio device is satisfied; and
initiating playback of the additional AR audio at the wearable audio device in response to receiving the data indicating that the additional AR audio playback condition is satisfied.

24. The computer-implemented method of claim 1, further comprising:
after or during playback of the interactive audio file, checking to determine whether settings attributed to the user permit superseding AR audio playback; and
in response to the settings attributed to the user allowing superseding AR audio playback, during the playback of the interactive audio file:
receiving data indicating an additional AR audio playback condition attributed to the user of the wearable audio device is satisfied; and
initiating playback of the additional AR audio at the wearable audio device in place of the interactive audio file in response to receiving the data indicating that the additional AR audio playback condition is satisfied.

25. The wearable audio device of claim 11, wherein the control system is further configured to:
after or during playback of the interactive audio file, checking to determine whether settings attributed to the user permit subsequent or superseding AR audio playback; and
either:
a) in response to the settings attributed to the user allowing subsequent AR audio playback and conclusion of playback of the interactive audio file:
receiving data indicating an additional AR audio playback condition attributed to the user of the wearable audio device is satisfied; and
initiating playback of the additional AR audio at the wearable audio device in response to receiving the data indicating that the additional AR audio playback condition is satisfied, or
b) in response to the settings attributed to the user allowing superseding AR audio playback, during the playback of the interactive audio file:
receiving data indicating an additional AR audio playback condition attributed to the user of the wearable audio device is satisfied; and
initiating playback of the additional AR audio at the wearable audio device in place of the interactive audio file in response to receiving the data indicating that the additional AR audio playback condition is satisfied.
